(19) United States
(12) Patent Application Publication
(10) Pub. No.: US 2019/0031102 A1
(43) Pub. Date: Jan. 31, 2019

(54) IMAGE DISPLAY SYSTEM FOR VEHICLE USE AND VEHICLE EQUIPPED WITH THE IMAGE DISPLAY SYSTEM

(71) Applicant: HON HAI PRECISION INDUSTRY CO., LTD., New Taipei (TW)

(72) Inventor: KATSUHIKO KISHIMOTO, Osaka (JP)

(21) Appl. No.: 16/073,781

(22) PCT Filed: Jul. 26, 2016
(86) PCT No.: PCT/JP2016/071850

§ 371 Date: Jul. 28, 2018

(30) Foreign Application Priority Data
Jan. 28, 2016 (JP) 2016-014140

(51) Int. Cl. B60R 1/00; H04N 5/247; H04N 5/445; H04N 5/232; G06K 9/00; G06T 7/73; G06T 7/20; G08B 21/06

(52) U.S. Cl. CPC B60R 1/00; G09G 3/3208; H04N 5/44591; H04N 5/23203; G06K 9/00845; G06K 9/00221; G06T 7/73; G06K 9/00791; G06T 7/20; G08B 21/06; B60R 2300/105; B60R 2300/20; B60R 2300/8026; G06T 2207/10048; G06T 2207/30268; G06T 2207/30201; G06T 2207/30252; G06K 9/00362; H04N 5/247

(57) ABSTRACT

An image display system for vehicle use that displays exterior information of a vehicle necessary for allowing a driver to travel more safely, such as an image of an areas to become blind spot on a screen of an image display device, and a vehicle equipped with the image display system are provided.

It comprises a plurality of image pickup devices 11a and 11b provided at predetermined positions in an exterior portion of the vehicle, a plurality of image display devices 14a to 14h provided in an interior portion of the vehicle, a line of sight. sensor 18 to sense eye position or a direction of a line of sight of a driver, and an image control device 19 to take an image of a predetermined area using an image pickup device located in the direction of the line of sight of the driver and to display an image taken by the image display device 11a or 11b on the image display device 14a or 14b corresponding thereto.

### TECHNICAL FIELD

The present invention relates to an image display system for vehicle use, especially, using image pickup devices and various kinds of sensing devices to display exterior in of the vehicle necessary for a driver to drive the vehicle more safely on screens of the image display devices, and a vehicle equipped with the image display system.

### BACKGROUND ART

Conventionally an image in a direction to become a blind spot is taken by art image pickup device installed at a rear portion of a vehicle such as a trunk, a back door, or the like, and the image of the direction to become the blind spot is displayed on an image display device such as a liquid crystal display device or the like provided on a dashboard or the like of a cockpit, so as to reduce an area of the blind spot much smaller.

Meanwhile, in Patent Literature 1 and Patent literature 2, as an application of an image display device using a flexible organic light emitting diode (hereinafter referred to as an OLED (Organic Light Emitting Diode)), it is proposed to install a wraparound image display device on a surface of a dashboard, a windshield, a ceiling, and so on of a vehicle to display various images thereon. In particular, in Patent Literature 1, it is proposed to install an image display device at a portion to become the blind spot when viewed from the driver, such as a pillar (a support pillar) between a window and a window, to take an image of the portion to become the blind spot by an image pickup device installed on an exterior of the vehicle, and to display the image on a screen of an image display device.

In addition, along with downsizing and high performance of the image pickup device and the image display device, so-called “mirrorless vehicles” having no door mirrors or fender mirrors protruding outward from the vehicle are headed for approval. On the other hand, there is a tendency to increase the number of pillars of a vehicle or to increase the thickness of a pillar from the viewpoint of safety at the time of a collision, so that an area of the blind spot from the driver tends to increase. Furthermore, an inclination of a hood and an inclination of a windshield are made substantially continuous from the design of the vehicle, so that there are also many vehicles in which so-called A-pillars located ahead the driver are dualized, and triangular windows are provided between them. As mentioned above, since the pillar itself tends to become thick, the field of view from the triangular window is extremely narrow. Still furthermore, since the seat is adjusted in the front-rear direction according to the physique of the driver, the area of the visibility or the blind spots varies depending on the eye location of the driver.

### CITATION LIST

### Patent Literatures

Patent Literature 1: JP 2013-122598 A

Patent Literature 2: JP 2009-328624 A

### SUMMARY OF INVENTION

The present invention has been conceived to solve the above-mentioned problems, and purposes to provide an image display system for vehicle use and a vehicle equipped with the image display system, in which images of areas to become blind spots from a driver or an image behind or a lateral of the vehicle taken with using an image pickup device or image pickup devices and various kinds of sensing devices installed on the vehicle, and exterior information necessary to the driver to drive the vehicle safely much more is displayed on screens of image display devices.

In order to achieve the above-mentioned purpose, an image display system for vehicle use according to the present invention comprises:

a plurality of image pickup devices provided at predetermined positions of an exterior of a vehicle to take images in predetermined areas, respectively;

a plurality of image display devices provided at predetermined positions of an interior of the vehicle to display an image taken by at least any one of a plurality of the image pickup devices on screens thereof;

a sensing device provided at a predetermined position of the exterior or the interior of the vehicle to sense a predetermined event; and

an image control device which controls one or more image pickup devices to take an image of a predetermined area or images of predetermined areas corresponding to the one or more image pickup devices among a plurality of the image pickup devices corresponding to the predetermined event when the sensing device senses the predetermined event, and controls at least one image display devices among a plurality of the image display devices to display one or more images corresponding to the one or more image pickup devices.

It may be configured that images taken by at least two of a plurality of the image pickup devices are displayed on any one of a plurality of the image display devices.

It may be configured that:

each of a plurality of the image pickup devices is provided in a vicinity of a causal object of the blind spot from a driver;

the sensing device is a line of sight sensor provided on the interior of vehicle to sense eye location or a direction of a line of sight of the driver; and

the image control device takes an image using at least an image pickup device located in a direction that is visible from sensed eye location among a plurality of the image display devices, senses an area to become the blind spot based on the eye location or the direction of the line of sight of the driver sensed, and corrects image data in a manner that an image of sensed area to become the blind spot from the driver is displayed on a screen of an image display device located at a position in the direction of the line of sight sensed among a plurality of the image display devices.

The line of sight sensor may be configured to include an image pickup device provided on the interior of the vehicle to take an image of a face of the driver with visible light, and an image processing device which performs a face recognition processing to image data taken by the image pickup device and senses the eye location or the direction of the line of sight of the driver.

Alternatively, the line of sight sensor may be configured to include an infrared ray image pickup device provided on the interior of the vehicle to receive infrared rays emitted from a face of the driver, and an image processing device which performs a thermographic processing to image data taken by the infrared ray image pickup device and senses the eye location or the direction of the line of sight of the driver.

It may be configured that:

each of a plurality of the image pickup devices takes an image in an area wider than an area of the causal object of the blind spot from the driver; and

the image control device shifts the image in a manner that a direction visible from the eye location sensed by the line of sight sensor and a predetermined direction specified by the cause object are to be positioned in a vicinity of a center of a screen of an image display device located in the direction visible from the eye location among a plurality of the image display devices.

In addition, it may be configured that an alarm device is further comprised, and the image control device determines whether the driver is dozing or not based on the direction of the line of sight of the driver sensed by the line of sight sensor, and outputs an alarm from the alarm device when it determines the driver is dozing.

Alternatively, it may be configured that:

the sensing device includes a first speed sensor for sensing a speed of the vehicle and a second speed sensor for sensing a speed of another vehicle traveling ahead, behind or lateral of the vehicle;

a plurality of the image pickup devices includes an image pickup device that takes an image of behind or lateral of the vehicle; and

the image control device displays an image taken by an image pickup device for taking the image of behind or lateral of the vehicle on an image display device located ahead the driver among a plurality of the image display devices, when a speed of another vehicle traveling ahead the vehicle is slower than the speed of the vehicle or when a speed of another vehicle traveling behind or lateral of the vehicle is higher than the speed of the vehicle.

It may be configured that the first speed sensor senses the speed of the vehicle from a speedometer of the vehicle, and the second speed sensor senses a relative speed between another vehicle traveling ahead, behind or lateral of the vehicle and the vehicle.

It may be configured that the second speed sensor performs an object recognition processing from image data taken by an image pickup device that takes an image ahead, behind or lateral of the vehicle and calculates the relative speed between another vehicle and the vehicle.

Alternatively, it may be configured that the sensing device is a speed sensor sensing device that senses the speed of the vehicle, and the image control device stops image taking operation of one or more image pickup devices previously set among a plurality of image pickup devices corresponding to the speed of the vehicle.

Alternatively, it may be configured that the sensing device includes a speed sensor for sensing the speed of the vehicle or a GPS (Global Positioning System) for sensing the position of the vehicle, and the image control device stops image taking operations of a plurality of the image pickup devices when the vehicle has not moved for a predetermined time or more.

Alternatively, it may be configured that the sensing device is an inter-vehicular distance sensor for sensing an inter-vehicular distance with another vehicle traveling ahead, behind, or lateral of the vehicle, and displays an image taken by an image pickup device which takes an image behind or lateral of the vehicle on an image display device located ahead the driver when the inter vehicular distance to another vehicle is shorter than a predetermined inter-vehicular distance.

It may be configured that the sensing device includes a speed sensor for sensing the speed of the vehicle, and a value of the predetermined inter-vehicle distance is varied corresponding to the speed of the vehicle.

It may he configured that the sensing device further includes a GPS (Global Positioning System), and a value of the predetermined inter-vehicle distance is varied corresponding to whether a load on which the vehicle is traveling is a general road or an expressway.

It may be configured that at least one of a plurality of the image display devices is an image display device using a flexible organic light emitting diode.

It may be configured that each of a plurality of the image pickup devices includes an infrared ray image pickup element for sensing a person existing within a predetermined area to be taken by the image pickup device.

Alternatively, it may be configured that the image control device determines whether a person exists in an image taken by a plurality of the image pickup devices or not.

Further, a vehicle provided with the image display system according to the present invention comprises any one of the above-described image display systems for vehicle use, wherein

at least a part of a plurality of the image pickup devices is provided in a vicinity of A-pillar of an exterior portion of the vehicle; and

at least a part of a plurality of the image display devices is an image display device using a flexible organic light emitting diode and is provided with A-pillar portion between a window and another window of the vehicle to be substantially continuous to the windows.

It may be configured that at least another part of a plurality of the image display devices is an image display device using a flexible organic light emitting diode and provided in a portion other than the pillar of the vehicle.

Alternatively, it may he configured that at least a part of a plurality of the image display devices is an image display device using an organic light emitting diode having translucency in a state of not emitting light.

According to the present invention, it is possible to take an image of an area that will become a blind spot from a driver and/or an image such as a vehicle approaching from behind or lateral of the vehicle using an image pickup device and various kinds of sensing devices, and to display exterior information of the vehicle necessary for a driver to drive the vehicle safely much more on the screens of the image display devices.

### BRIEF DESCRIPTION OF DRAWINGS

FIG. 1 is a view showing a cockpit of a vehicle equipped with an image display system according to an embodiment of the present invention.

FIGS. 2A and 2B are plan views showing areas of blind spots from a driver due to pillars of a vehicle and installation positions of image pickup devices of the image display system corresponding thereto.

FIG. 3 is a block diagram showing a configuration of the image display system according to an embodiment of the present invention.

FIG. 4 is a view showing a modification of a cockpit of a vehicle equipped with an image display system according to an embodiment of the present invention.

FIG. 5 is a plan view showing areas of blind spots from a driver due to doors of a vehicle and installation positions of image pickup devices of the image display system corresponding thereto.

FIG. 6 is a view showing a modification of a cockpit in which an image display system according to an embodiment of the present invention is applied to a mirrorless vehicle.

FIGS. 7A and 7B are views showing a modification of a cockpit in which an image display system according to an embodiment of the present invention is applied to a vehicle having triangular windows in so-called A-pillar portions.

### DESCRIPTION OF INVENTION

The present invention relates to an image display system for vehicle use that displays exterior information of the vehicle necessary for a driver to drive the vehicle safely much more on screens of image display devices using image pickup devices and various sensing devices, and a vehicle equipped with the image display system, and will be described based on the following embodiments according to sensed events by sensing devices.

### First Embodiment

An image display system for vehicle use and a vehicle equipped with the image display system according to a first embodiment of the present invention will be described. In a conventional image display system for vehicle use, an area of an image taken by an image pickup device and an area of an image displayed on a screen of an image display device are fixed, so that an area to become a blind spot from a driver and the area of the image displayed on the screen of the image display device are not always coincided with each other when a position of a seat is adjusted according to the physique of the driver. In contrast, the first embodiment of the present invention is configured to correct an image displayed on an image display device according to an area of a visual field or a blind spot which will be changed according to eye location of a driver. A line of sight sensor is used as the sensing device, and the eye location or a direction of the line of sight of the drive is sensed as an event to be sensed.

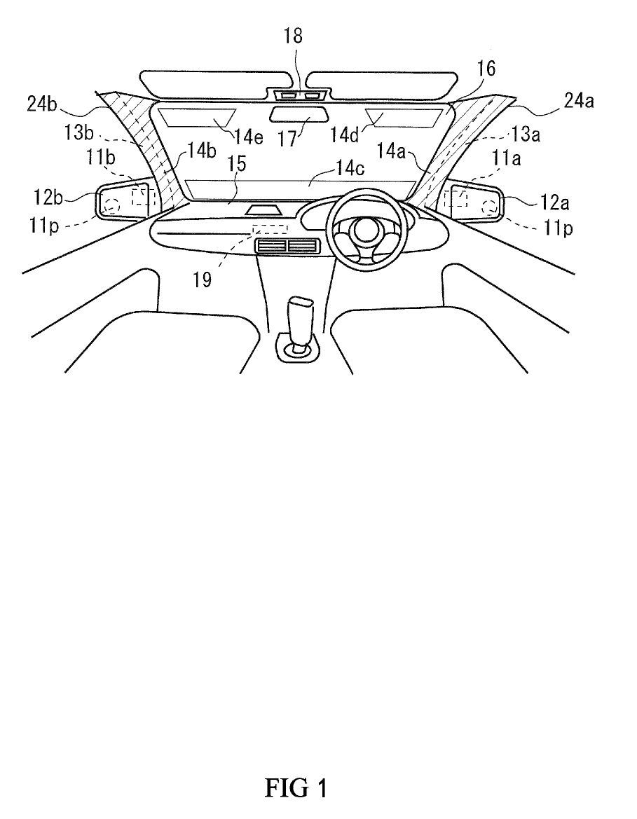

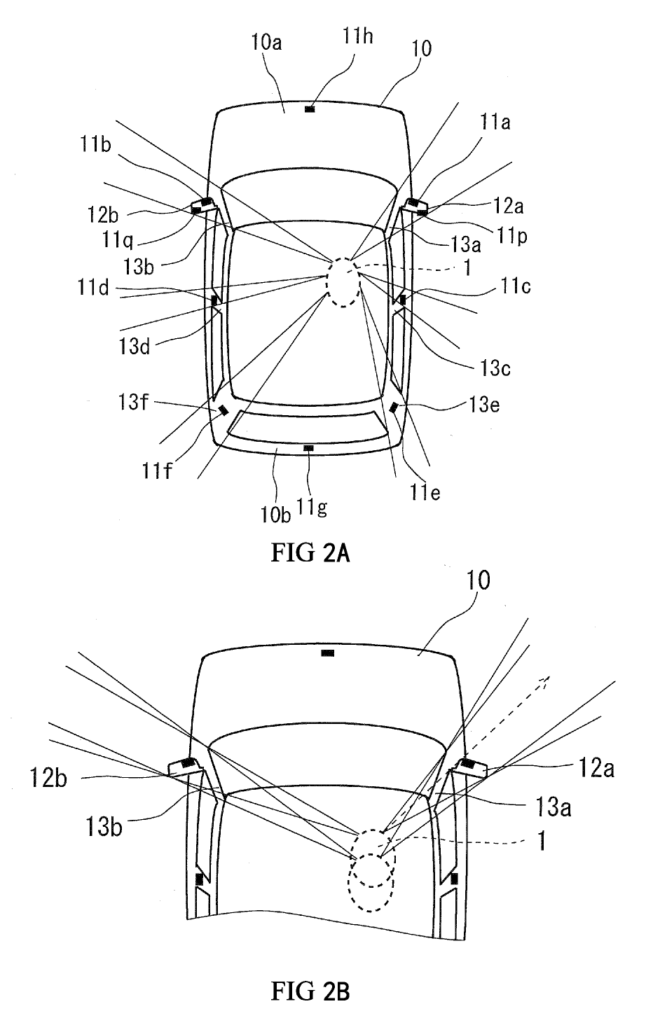

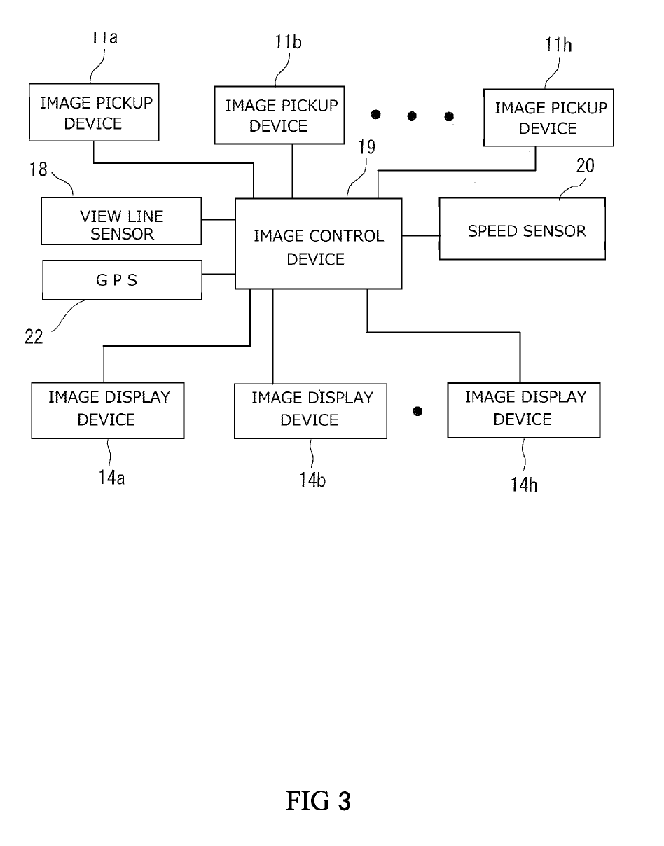

FIG. 1 shows a cockpit of a vehicle equipped with the image display system according to the first embodiment. FIG. 2A is a plan view observed just above the vehicle showing the areas of the blind spots from the driver and the installation positions of the image pickup devices which will be described later, and FIG. 2B shows a situation of change of the areas of the blind spots depending on the position of the driver's seat and so on. FIG. 3 is a block diagram showing a configuration of the image display system for vehicle use. Although constituent elements which will be used in other embodiment described later are illustrated in these FIGS. 1, 2A, 2B and 3, these constituent elements will be explained in the embodiments in which those constituent elements are used.

As shown in FIG. 2A in the image display system for a vehicle according to the first embodiment, a plurality of image pickup devices 11a to 11h each for taking an image in a predetermined area is installed at predetermined positions of an exterior a vehicle 10. The installation positions of the image pickup devices 11a to 11h are in the vicinities of causal objects to become blind spots from a driver 1 such as a hood, a front grill or a bumper 10a, a door mirrors 12a and 12b a back door or a trunk 10b, pillars 13a to 13f, and so on. Each of the pillars 13a to 13f is called an A-pillar, a B-pillar, a C-pillar sequentially from the front of the vehicle 10. In the first embodiment, since the door mirrors 12a and 12b are provided on both side surfaces of the vehicle 10, the image pickup devices 11a and 11b for taking images of the areas to become the blind spots due to the A-pillars 13a and 13b are respectively provided in the door mirrors 12a and 12b, however, they may be provided in the A-pillars 13a and 13b. Furthermore, in the present embodiment, it is assumed that the door mirrors 12a and 12b are foldable type, and thus, it is exemplified that the image pickup devices 11p and 11q are provided on the base portions fixed to the vehicle 10. At this time, in a state where the door mirrors 12a and 12b are folded, protective caps for dustproof and antifouling are placed on the image pickup lenses of the image pickup devices 11a and 11b, and in a state where the folding is released, the protective caps of the image pickup lenses are opened. Of course, the present invention is not limited to this, and the image pickup lenses of the image pickup devices 11p and 11q may he directly exposed at all times. In addition, the image pickup lenses may he provided on the movable portions (main body) of the door mirrors.

As shown in FIG. 1, a plurality of image display devices 14a to 14e is provided at predetermined positions corresponding to the image pickup devices 11a and 11b. For example, the image display devices 14a and 14b are provided on the A-pillars 13a and 13b, which are causal objects that become blind spots from the driver 1, to display images taken by the image pickup devices 11a and 11b on their display screens. The image display devices 14a and 14b are the image display devices using flexible organic light emitting diodes (OLEDs), and as indicated by hatching in the drawing, the image display devices 14a and 14b are installed on the inner trims of the A-pillars 13a and 13b so as to be continuously arranged with a windshield 16 and door glasses 24a and 24b. By taking images in predetermined areas by the image pickup devices 11a and 11b and displaying the images in the areas of the blind spots due to the A-pillars 13a and 13b on the image display devices 14a and 14b, a scenery visible through the windshield 16 and the images displayed on the image display devices 14a and 14b and a scenery visible through the door glasses 24a and 24b are continuous, so that it can generate a sense of openness to the driver as if the A-pillars 13a and 13b do not exist. In particular, since the responsiveness of the OLEO is much faster than that of the liquid crystal display, the image can be switched at high speed even when the vehicle 1 is in high speed traveling, so that the driver 1 is less likely to feel unnatural. In addition, unlike the liquid crystal display, since the response speed of the OLEDs does not decrease even at low temperatures, it is possible to display a good quality even in the extremely cold interior environment of the vehicle in winter. Furthermore, since the image display devices 14a and 14b are provided near the eye location of the driver 1, it is possible to make the resolution much finer than that of the liquid crystal display. It is preferable to use OLEDs rarely having view angle dependency. Although not shown, image display devices using flexible OLEDs may be provided on the inner trims of the B-pillars 13c and 13d and the C-pillars 13e and 13f in the center portion of the vehicle. Furthermore, image display devices using translucent OLEDs may be provided on the door glasses in the vicinities of the B-pillars 13c and 13d and the C-pillars 13e and 13f. Still furthermore, an image display device using an OLED may be provided also in a dashboard 15, if necessary. It may be configured that a map image of a car navigation system is displayed while driving or an image of a television broadcast and so forth are displayed while parking, in addition to the images taken by the image pickup devices.

In addition, a plurality of image display devices 14c, 14d, 14e and so on for displaying images taken by any one of the other image pickup devices 11c to 11h is respectively provided at upper portions and at lower portion of the windshield 16 other than the pillar portions. The image display devices 14c to 14e are image display devices using OLEDs having flexibility and translucency. For example, when starting the vehicle 10 to move, by displaying an image taken by the image pickup device 1111 installed on the front of the vehicle 10 on the image display device 14d or 14c provided at the upper or lower portion of the windshield 16, it is possible to confirm safety in an area to become blind spots due to the hood 10a and so on. Furthermore, after starting the vehicle 10 or when moving the vehicle backward, it may switch the image to be displayed on the image display device 14c. to an image taken by the image pickup device 11g provided on the rea of the vehicle 10. Still furthermore, images taken by the image pickup devices 11c to 11f and so on provided on side surfaces of the vehicle 10 may be displayed on the image display devices 14d and 14e provided at upper portions of the windshield 16. Switching between these image displays may be automatically performed in response to the speed of the vehicle 10 or the position of the selector lever or the shift lever, or it may be performed in response to switching operation of a switch by the driver 1. Besides, the sizes and positions of the display screens of the image display devices 14c, 14d, and 14e are not limited in particular, and it may be configured that a single display screen is divided into a plurality of sections, and images taken by different image pickup devices are displayed in each section.

Since the image display devices 14a to 14e using the OLEDs have characteristics easily be affected by ultraviolet rays and heat, it is preferable to use a glass having ultraviolet ray cutoff (absorption or reflection) and infrared ray cutoff (reflection) performance as the windshield 16 and the door glasses 24a and 24b. In addition, in a case where a line of sight sensor 18, which will be described later, senses infrared rays emitted from a human body to sense the direction of the line of sight, if infrared rays contained in the sunlight enter the vehicle a lot, it may be difficult to sense an eyeball portion of the driver 1. Therefore, it is preferable to use an infrared cutoff glass that can cut off infrared rays with a wavelength of around 2 μm by 90% or more, for example. Also, ultraviolet cutoff glasses generally used for vehicles are those which cut off ultraviolet rays by 99% or more. However, from the viewpoint of avoiding irradiation of ultraviolet rays to the image display devices 14a to 14e as much as possible, it is preferable to select the ultraviolet ray cutting rate preferably 99.9% or more, more preferably 99.99% or more.

In addition, the line of sight sensor 18 for sensing the eye location of the driver 1 or direction of the line of sight is provided at an interior portion of the vehicle 10, for example, at a ceiling portion above the room mirror 17. The line of sight sensor 18 is configured of an image pickup element to take an image of a face of a driver with visible rays and an image processing device to perform a face recognition processing from image data taken by the image pickup element, and to sense, an eye location or a direction of line of sight of the driver, for example. Alternatively, the line of sight sensor 18 may be configured to include an infrared ray image pickup element (an image pickup element having sensitivity in the infrared region) to receive far infrared rays emitted from the face of the driver, and an image processing device to perform a thermographic processing to image data taken by the image pickup device and to sense an eye location or a direction of line of sight of the driver from temperature distribution. The position of the line of sight sensor 18 is not limited in particular and it may be any position as long as it can take an image of the face of the driver, in other words, it may be provided within an area that comes into the field of view of the driver. In addition, these image processing devices can be shared by an image control device 19 which will be described later.

As shown in FIG. 2B, when driving the vehicle 10 the driver 1 adjusts the position of the seat corresponding to his or her physique. Also, the height of the eyes is different according to the physique of the driver 1. Therefore, depending on the eye location of the driver 1, the areas of the blind spots due to the door mirrors 12a and 12b and the pillars 13a and 13b vary. In addition, when attempting to start the vehicle, the driver shakes his or her face to left and right to confirm the safety in forward left and forward right of the traveling direction. Similarly, when turning right or left, the safety in the direction of turning is confirmed, however, the speed has reached a certain level different from the case of starting from the stopped state, so that it is generally considered that the driver moves his or her eyes left and right with moving his or her face not so much. Therefore, as mentioned above, by sensing the eye location or the direction of the line of sight of the driver by the line of sight sensor 18, it is possible to correspond to the variation of the areas of the blind spots due to the differences of the location or height of the eyes on the face caused by the physique of the driver or the direction of the face. In addition, in case of changing the lane or moving the vehicle backward, the driver may shake the neck sideways or turn around, so that line of sight sensors 18 may be provided at not only the front portion of the vehicle but also side portions or a rear portion of the vehicle.

As shown in FIG. 3, the image display system for vehicle use includes an image control device 19, and the image pickup devices 11a to 11h, the image display devices 14a to 14e, and the line of sight sensor 18 are connected to the image control device 19, respectively. When displaying the images taken by the image pickup devices 11a to 11h on the screens of the image display devices 14a to 14e, the image control device 19 not only controls start and end of image pickup operations of the image pickup devices 11a to 11h and star and end of image display operations of the image display devices 14a to 14e, but also correct image data as an image correction device.

As a first image correction method by the image control device 19, each of the image pickup devices 11a to 11h may pick up an image in an area wider than the area of the blind spots from the driver 1 due to the above-mentioned causal object, and the image control device 19 may shift (translate) the image in a manner so that a predetermined direction specified by the eye location sensed by the line of sight sensor 18 and the causal object is positioned in the vicinity of the center of the screen of the image display device located in a visible direction from the sensed eye location. For example, as shown by a broken line arrow in FIG. 2B, when the eye location of the driver 1 is sensed, the image is corrected in a manner so that a direction of a line binding the eye location and the A-pillar 13a as the causal object is located at the center of the display screen of the image display device 14a. In this way, the method of processing the image data by the image control device 19 enables the driver 1 to recognize a natural image by correcting the image so as to bend the image in a direction opposite to a curvature of a screen when the screen of any one of the image display devices 14a to 14e is curved.

As a second image correction method by the image control device 19, each of the image pickup devices 11a to 11h may pick up an image in an area substantially the same as the area to be displayed on the screen of the image display device corresponding thereto, and the image control device 19 may adjust the attitude of an image pickup device located in a direction visible from the eye location sensed by the line of sight sensor 18 in a manner so that an optical axis of the image pickup device is oriented in a predetermined direction specified by the sensed eye location and the causal object. In this way, the method directly varying the orientation of the optical axis of the image pickup device enables to omit processing of the image data by the image control device 19 when the screens of the image display devices 14a to 14e are flat.

### Second Embodiment

In a second embodiment, an image pickup device to take an image is appropriately switched or image taking operation by the image pickup device is stopped corresponding to the speed of the vehicle 10. As shown in FIG. 3, a speed sensor 20 such as a speedometer of the vehicle 10 and a GPS (Global Positioning System) 22 are used as the sensing devices to sense the speed and the current position of the vehicle as the events to be sensed, in addition to the line of sight sensor 18.

When starting the vehicle to move forward or backward from the stopped state, the driver steers the vehicle 10 while confirming the safety in the direction to move the vehicle 10. Accordingly, the image pickup devices 11a to 11h are not necessarily always-on to take images, and the image control device 19 may control at least an image pickup device among a plurality of the image pickup devices 11a to 11h which is located in a visible direction from the eye location or the direction of the line of sight sensed by the line of sight sensor 18 and to display an image only on an image display device corresponding to the image pickup device or image pickup devices. In addition, in ease that the driver is on the vehicle 10 but the engine is not starting or in case that the engine is starting but the vehicle 10 has not moved for a certain period of time, when the image control device 19 determines that the vehicle has not moved for a certain period of time or more from the output of the speed sensor 20 or the GPS 22, it may control to stop image pickup operation of all the image pickup devices 11a to 11h and to stop image display operation of all the image display devices 14a to 14e. Alternatively, even when the vehicle has not moved, the image control device 19 may control image pickup operation of all or designated image pickup devices and image display operation of all or designated image display devices responding to switching operation by the driver.

Furthermore, when the speed of the vehicle becomes equal to or higher than a certain speed (for example, 30 km/h or more), it is unlikely to steer the vehicle at a steep angle in the direction to become the blind spot due to the A-pillar 13a or 13b, for example. Therefore, when the speed of the vehicle reaches to the certain speed or more, the image control device 19 may control to stop the image pickup operation by the image pickup devices positioned ahead the driver 1 such as the image pickup devices 11a and 11b installed on the door mirrors 12a and 12b and the image pickup device 11h installed on the front grill, and so on. In such a case, as shown in FIG. 1 and FIG. 2A, image pickup devices 11p and 11q may be provided on the door mirrors 12a and 12b to take images behind the vehicle 10, and the image control device 19 may control the image display devices 14a and 14b to display the images taken by the image pickup devices 11p and 11q. FIG. 1 shows an example that the door mirrors 12a and 12b are half mirrors and the image pickup devices 11p and 11q are provided inside the half mirrors. However, the present invention is not limited to this and the image pickup lenses of the image pickup devices 11p and 11q may be directly exposed. Furthermore, the image pickup devices 11p and may be provided on the body of the vehicle 10, not on the, door mirrors 12a and 12b.

### Third Embodiment

In a third embodiment, another vehicle traveling ahead, behind, or lateral of the vehicle 10 is sensed from an image taken by an image pickup device while traveling, and exterior information in a circumference of the vehicle 10, in particular, dangerousness that the other vehicle touching the vehicle 10 comes close to is transmitted to the driver based on the information such as an inter-vehicle distance to the other vehicle or a relative speed between the vehicle 10 and the other vehicle. As the sensing devices, the image pickup devices 11a, 11b and 11h to sense the inter-vehicle distance or speed of another vehicle traveling ahead the vehicle 10, and the image pickup devices 11p and 11q to sense a relative speed of another vehicle travelling behind or lateral of the vehicle 10, and the image control device (serving as a second speed sensor) 19 are used, in addition to the speed sensor (serving as a first speed sensor) 20 such as a speedometer of the vehicle 10 and the GPS 22. The speed of the vehicle 10, the inter-vehicle distance to another vehicle, information whether the road currently travelling is a general road or an expressway are sensed as events to be sensed. Incidentally, the speed of the vehicle referred to here can include accelerations obtained by differentiating the speed with time. Furthermore, as a method of sensing the relative speed between the vehicle 10 and another vehicle, millimeter waves, infrared laser beams, ultrasonic waves, or the like may be irradiated to sense reflected waves from another vehicle.

In the case of lane change, only the images reflected by the door mirrors 12a and 12b are insufficient as exterior information of the vehicle for allowing the driver to travel the vehicle more safely. In particular, in case of overtaking a vehicle traveling ahead the vehicle at a high speed in an expressway, it is necessary to change the lane from the traveling lane to the passing lane while accelerating. However, there are many vehicles continuously traveling on the passing lane at a high speed faster than that of the own vehicle. Therefore, if the driver confirms the distance to another vehicle traveling behind with the door mirror 12a or the like and intends to change the lane, another vehicle may have approached at the closest distance. Alternatively, even on a general road, if a lane change is made to overtake a low speed vehicle ahead there is a case where a vehicle traveling behind intends to change the lane simultaneously. Furthermore, there is a case to make a distance to a vehicle ahead because a vehicle traveling behind is approaching too close and sudden braking will cause a rear-end collision. Still furthermore, when overtaking a bicycle or a motorcycle or the like traveling on a shoulder of a road, it may be necessary to travel bridging over the lanes in order to prevent a contact accident. Alternatively, a bicycle or a motorcycle may try to pass through the side of the vehicle during a traffic jam. When the inter-vehicle distance to another vehicle traveling ahead the vehicle 10 is shorter than a predetermined inter-vehicle distance, when the speed of another vehicle traveling ahead the vehicle 10 is slower than the speed of the vehicle 10, or when the speed of another vehicle traveling behind or lateral is faster than the speed of the vehicle 10, the image control device 19 may display the images taken by the image pickup devices 11c to 11g, 11p and 11q for taking images behind or lateral of the vehicle 10 on the image display devices 14a to 14e, and so on. In such a case, the images to be displayed on the image display devices 14a to 14e may include characters or symbols for urging a warning in addition to the images taken by the image pickup devices 11c to 11g, 11p and 11q, or a part of each image may be highlighted. Additionally, alarm sounds may be emitted simultaneously.

In the configuration shown in FIG. 3, since the image control device 19 serving as the second speed sensor is connected to the GPS 22, it is possible to determine whether the vehicle is traveling on an expressway or a general road. In addition, since the image control device 19 is connected to the speed sensor 20, it is also possible to determine at what speed the vehicle 10 is traveling, or whether accelerating or decelerating. Therefore, when the speed of the vehicle is equal to or higher than a certain speed (for example, 60 km/h) and/or the vehicle is accelerating or decelerating, or in conjunction with an operation of a turn signal, or the like, the image control device 19 may display the images taken by the image pickup devices 11p and 11q provided backward on the door mirrors 12a and 12b and the image pickup devices located behind the driver such as the image pickup devices 11c to 11g provided on the B-pillars 13c and 13d and C-pillars 13e and 13f and the back door on the image display devices 14a to 14e located ahead the driver.

In addition it may be configured that the image control device 19 further serves as an inter-vehicle distance sensor to perform object recognition processing from image data taken by an image pickup device located behind the driver, and to sense a distance to another vehicle or a speed of another vehicle traveling behind or lateral of the vehicle. In recent years, the number of vehicles equipped with safety equipment such as automatic braking device is increasing. However, the automatic braking device uses two image pickup elements, and a distance to a vehicle traveling ahead is measured by the triangulation, for example. By applying this technique, it is possible to measure distances to another vehicle traveling ahead or behind by providing two image pickup elements in the image pickup devices 11a to 11h. If the speed of another vehicle traveling lateral or behind is faster than the speed of the vehicle, a size of the image of the recognized object gradually increases, so that the image control device 19 can sense approaching of a vehicle from lateral or behind. If an inter-vehicle distance to another vehicle traveling lateral or behind is shorter than a certain distance corresponding to the speed of the vehicle 10, or if a speed of another vehicle is faster than the speed of the vehicle 10, the image control device 19 may be configured to display images taken by the image pickup devices to take the image behind the vehicle 10 on the image display devices 14a to 14e located ahead the driver. Thereby, the driver can confirm the conditions lateral or behind the vehicle while looking forward. Furthermore, in order to call attention of the driver, it may be configured to display not only the images but also characters or symbols such as “pay attention to contact” additionally, or another vehicle that is likely to come into contact is emphasized in the displayed image, or an alarm sound is outputted from an alarm device. Still furthermore, a value of the above-mentioned intervehicle distance may be switched in response to whether the vehicle 10 traveling on the expressway or on the general road. As the inter-vehicle distance sensor, in addition to using the above-mentioned image pickup devices, it may be configured to measure a distance to a vehicle traveling ahead, behind or lateral with using a millimeter wave radar, an infrared radar, or the like.

### Fourth Embodiment

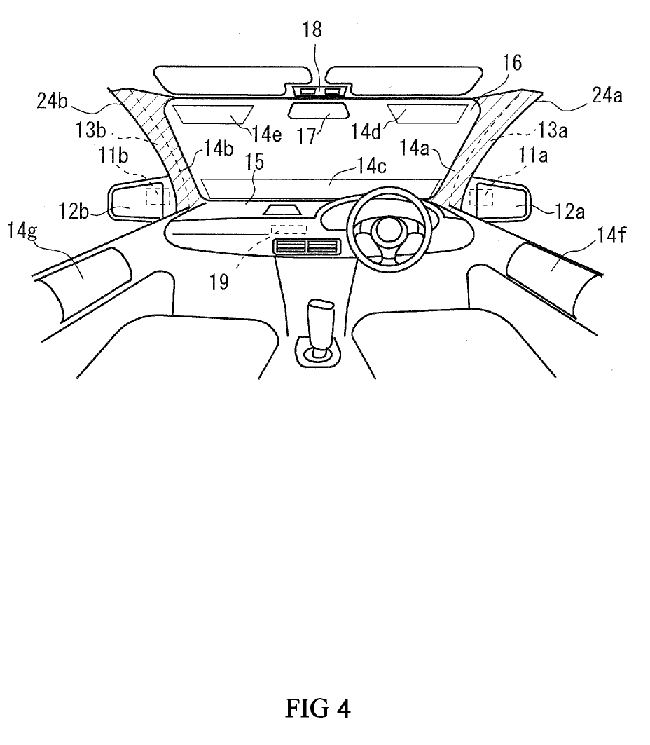

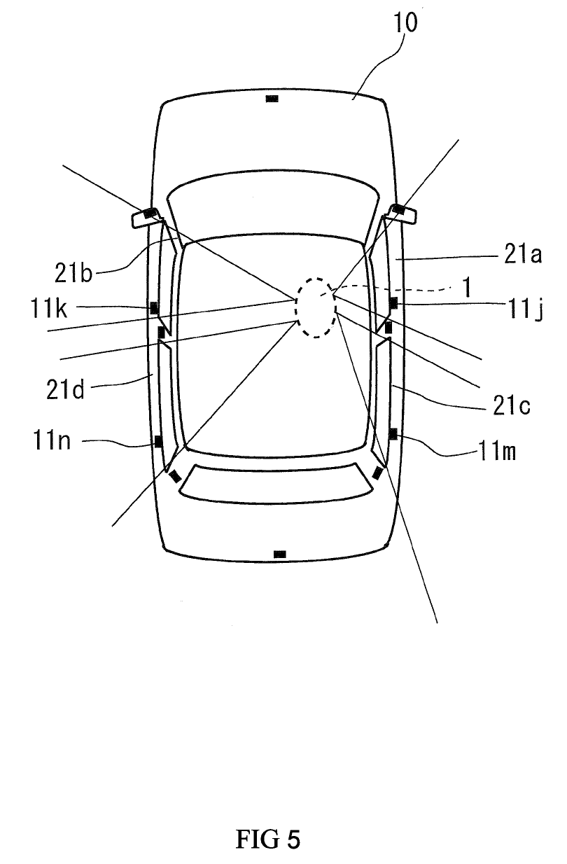

In a fourth embodiment, blind spots due to doors are reduced when parking the vehicle 10 in a garage or when opening and closing the doors. In general, the portions below the windows of the doors also become blind spots as viewed from the driver or passenger. As shown in FIG. 4 and FIG. 5, image pickup devices 11j, 11k, 11m and 11n are provided on the door knobs and the like of the doors 21a to 21d, and image display devices 14f and 14g and the like are provided on upper portions of door trims. As a sensing device, a selector lever or a shift lever is used to sense that the selector lever or the shift lever is in a reverse position, neutral or parking, or the like, or a side brake is set, which are events to be sensed.

In case of parking into the garage, there is a possibility of rubbing the vehicle 10 with obstacles or the like existing below the windows. Therefore, when the selector lever or the shift lever enters the reverse position, the image control device 19 serving as the control device starts taking the images b the image pickup devices 11j, 11k, 11m, and 11n, and displays the images on the image display devices 14f and 14g provided on the door trims of the doors other than the pillars 13a to 13f of the vehicle 10, for example. Thereby, the driver 1 can confirm the situations on both sides of the vehicle. Furthermore, even in the state where the parking brake is set or in the state where the selector lever is in the parking position, image taking operations by the image pickup devices 11j, 11k, 11m and 11n may be started to display the images on the image display devices 14f and 14g or the like provided on the door trims of the doors. According to such a configuration, it is possible to open the door after confirming the situations on both sides of the vehicle which will be the blind spots due to the doors. In such a case, it is preferable to use the image display devices using flexible OLEDs as the image display devices 14f and 14g, and it is preferable to use ultraviolet cutoff (absorption or reflection) and infrared cutoff (reflection) glass as the window glass of each of the doors.

### Fifth Embodiment

In a fifth embodiment, the image display system for vehicle use according to the present invention is applied to a so-called mirrorless vehicle. The sensing devices and the events to be sensed may include all those described in the previous embodiment.

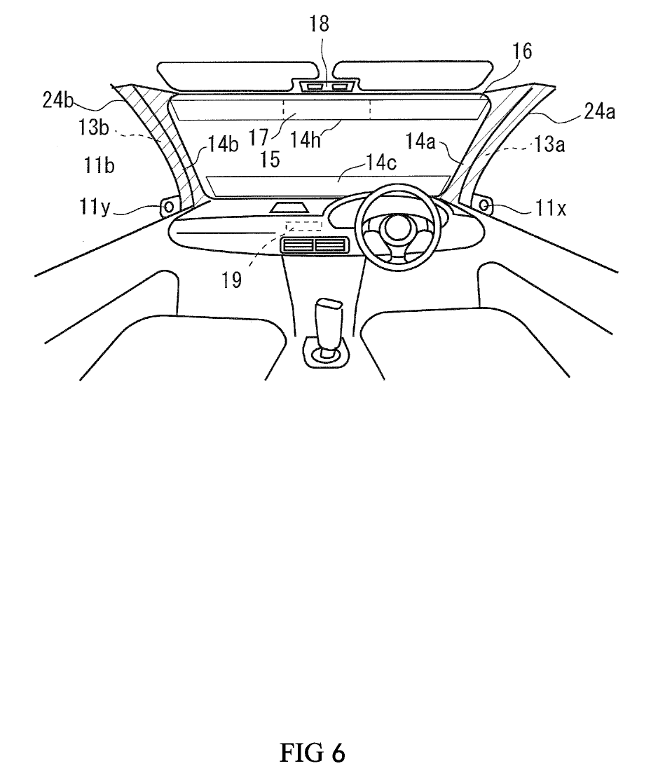

As shown in FIG. 6, in the mirrorless vehicle, image pickup devices 11x and 11y are provided in place of the conventional door mirrors 12a and 12b. The image pickup devices 11x and 11y include front image pickup lenses and front image pickup elements for displaying (SIC) images in areas of blind spots due to the A-pillars 13a and 13b, rear image pickup lenses and rear image pickup elements for taking images behind the vehicle. The images taken by the front image pickup elements of the image pickup devices 11x and 11y may be displayed on the image display devices 14a and 14b provided on the A-pillars 13a and 13b, and the images taken by the rear image pickup elements may be displayed on left and right portions of the image display device 14e provided at lower portion of the windshield 16. In addition, it may be configured that an image display device 14h using an OLED with a wide lateral width is provided on an inner upper portion of the windshield 16 instead of the room mirror 17, and an image taken by the image pickup device 11g provided on the back door or the trunk 10b is displayed on a center portion of the image display device 14h.

### Sixth Embodiment

In a sixth embodiment, the image display system for vehicle use of the present invention is applied to a vehicle having triangular windows in the A-pillar portions such as a so-called one box car. The sensing devices and the events to be sensed may include all those described in the previous embodiment.

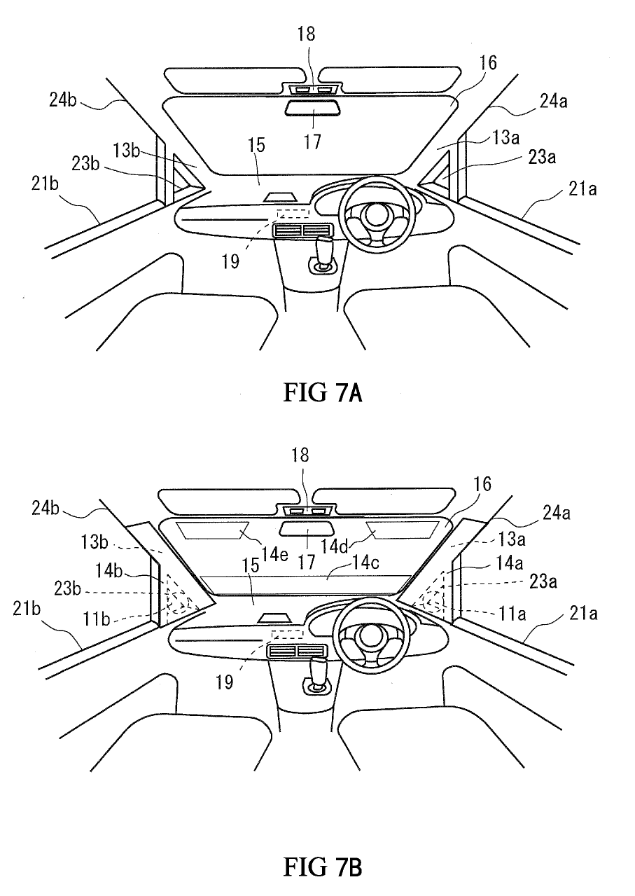

As shown in FIG. 7A, even in a vehicle type called one box car, it is designed that a portion ahead the cockpit becomes longer in consideration of shock absorbing property at the time of a collision and the like. Then, from the design of the vehicle, the inclination of the hood and the inclination of the windshield 16 are substantially continuous, and the inclination of the front A-pillars 13a and 13b is gentle in comparison with a vehicle type called a sedan. On the other hand, since the positions of the hinges of the doors are not changed so much even with the one box car, triangular windows 23a and 23b are provided between the doors 21a and 21b and the A-pillars 13a and 13b (dualization of the A-pillar). As mentioned above, since the pillars themselves tend to be thick, the fields of view from the triangular windows 23a and 23b are extremely narrow from the viewpoint of the driver, so it is not very useful.

Therefore, in the sixth embodiment, as shown in FIG. 7B, inside the A-pillars 13a and 13b, the image display devices 14a and 14b are provided so as to be substantially continuous with the windshield 16 and the door glasses 24a and 24b. The image pickup devices 11a and 11b may be provided inside the triangular windows 23a and 23b instead of the door mirrors 12a and 12b. In comparison with the configuration example shown in FIG. 1. since the image display devices 14a and 14b are configured to be substantially flat, OLEDs not having flexibility can be used. By displaying the images in the areas of the blind spots due to the A-pillars 13a and 13b on the image display devices 14a and 14b, the scenery visible through the windshield 16, the images displayed on the image display devices 14a and 14b and the scenery seen from the glasses 24a and 24b are continuous, and it is possible to give the driver 1 a sense of openness as if the A-pillars 13a and 13b do not exist.

### Other Application Examples

As an application example of the line of sight sensor 18 and the image control device 19, the image control device 19 serving as the control device may determine whether the driver is dozing or not based on the eye location or the direction of the line of sight or whether or not the eyes are closed sensed by the line of sight sensor 18 and may output an alarm sound via an alarm device or the like.

Also, even during the daytime, the driver may accidentally overlook the image in the area of the blind spot taken by the image pickup device. It may be configured that the image control device 19 determines whether a person exists in an image or not by performing a face recognition processing or the like using the image data taken by each of the image pickup devices 11a to 11h under natural light, and when it is judged a person exists in the area, the person is displayed with highlighting and outputs an alarm sound via an alarm device or the like. If it is nighttime, since it is dark except for an area irradiated by the headlight, it is difficult to determine whether a person exists in an image or not even when the images displayed on the image display devices 14a to 14h taken by the image display devices 11a to 11h are observed only. However, in recent years, since the sensitivity of the image pickup device using a CCD or the like has been improved, it is possible to perform a face recognition processing or the like using the image data taken by each of the image pickup devices 11a to 11h by setting the sensitivity of the image pickup element to a high value, and to give an alarm to the driver by highlighting a person when it is judged that a person exists or to draw the driver's attention by outputting an alarm sound via an alarm device or the like.

Furthermore, it may be configured that a light source for irradiating near infrared rays and an infrared ray image pickup element having sensitivity to near infrared rays are provided on each of the image pickup devices 11a to 11h, corresponding to a case where there is no such thing as a light source in the surroundings, and the images of near infrared rays taken by the infrared ray image pickup elements are displayed on the screens of the image display devices 14a to 14h. In such a case, it is also possible to recognize obstacles other than a person or persons and an animal or animals existing in a circumference of the vehicle 10. It is preferable that the image displayed on the image display devices 14a to 14h be a so-called monochrome image, which is more natural. Alternatively, it may be configured that an infrared ray image pickup element having sensitivity to far-infrared rays is provided in each of the image pickup devices 11a to 11h to receive far infrared rays emitted from a person, animals, or the like, and to display the far infrared ray image taken by the infrared ray image pickup element is displayed on each screen of the image display devices 14a to 14h as a thermography. Furthermore, only the body surface temperature of a person may be displayed in a specific color (for example, red) so as to distinguish from other objects.

Although a front surface of the image pickup lens of each of the image pickup devices 11a to 11h is protected by a translucent and waterproof protective cover, mud, floating matters in the air, and the like adhere to the surface of the protective cover. Therefore, at least a part of the image pickup devices 11a to 11h may he provided with a cleaning device for cleaning the surface of the protective cover. As an example of a cleaning device, in case of the image pickup devices 11a and 11b provided on the door mirrors 12a and 12b, it may he configured to sweep the surface of the protective covers of the image pickup devices 11a and 11b by bushes or wipers provided inside the door mirrors 12a and 12b each time when the door mirrors 12a and 12b are folded or drawn out, for example. Furthermore, a structure may be provided such that the image pickup lenses and the protective covers of the image pickup devices 11a and 11b are housed inside the door mirrors 12a and 12h ire a state where the door mirrors 12a and 12b are folded. Alternatively, a structure may he provided such that protective caps are covered over the image pickup lenses and the protective covers of the image pickup devices 11a and 11b, in conjunction with the operation to fold the door mirrors 12a and 12b. Alternatively, it may be a structure to make it difficult for foreign matter to adhere to the surfaces of the protective covers of the image pickup devices 11a and 11b using ultrasonic vibration or the like.

Furthermore, the image pickup devices 11c to 11h installed on the B-pillars 13c and 13d, the C-pillars 13e and 13f, the hood 10a, the back door or the trunk lob, or the like may he incorporated in parts such as emblems of the vehicle, for example. Then, it may be configured to sweep the surfaces of the protective covers of the image pickup devices 11c to 11h by brushes or wipers provided inside the emblems each time when the engine is activated, for example.

There is no need to say that the present invention is not limited to the scope described in the description of the embodiment and the drawings, but it is also applicable to motorcycles, cargo vehicles, railway vehicles and the like other than passenger cars. In case of the motorcycle, an image pickup device is installed in a backward-looking manner and an image display device using an OLED having flexibility and translucency is installed on the windshield to improve visibility of the backward view. Furthermore, the number, the installation position, the type, the structure, and the like of the image pickup devices and the image display devices are not limited in particular. Still furthermore, the present invention can also be applied to vehicles other than wheeled vehicles, such as gondolas in amusement parks, ships such, as glass boats overlooking underwater, aircraft for scenic flight and the like, for example.

### REFERENCE SIGNS LIST

1 Driver
10 Vehicle
10a Hood or Front grill or Bumper
10b Back door or Trunk
11a to 11h Image pickup device
11j, 11k, 11m, 11n, 11p, 11q, 11x, 11y Image pickup device
12a, 12b Door mirror
13a to 13f Pillar
14a to 14h Image display device
15 Dashboard
16 Windshield
17 Room mirror
18 Line of sight sensor
19 Image control device
20 Speed sensor
21a to 21d Door
22 GPS
23a, 23b Triangular window
24a, 24b Door glass

1. An image display system for vehicle use comprising:
a plurality of image pickup devices provided at predetermined positions of an exterior of a vehicle to take images in predetermined areas, respectively;
a plurality of image display devices provided at predetermined positions of an interior of the vehicle to display an image taken by at least any one of a plurality of the image pickup devices on screens thereof;
a sensing device provided at a predetermined position of the exterior or the interior of the vehicle to sense a predetermined event; and
an image control device which controls one or more image pickup devices to take an image of a predetermined area or images of predetermined areas corresponding to the one or more image pickup devices among a plurality of the image pickup devices corresponding to the predetermined event when the sensing device senses the predetermined event, and controls at least one image display devices among a plurality of the image display devices to display one or more images corresponding to the one or more image pickup devices, and
a single display screen of an image display device among a plurality of the image display devices is divided into a plurality of sections, and images taken by different image pickup devices are displayed in each section.

2. The image display system for vehicle use according to claim 1, wherein
the single display screen of the image display device to be divided into a plurality of sections is provided at upper portions and at lower portion of the windshield.

3. The image display system for vehicle use according to claim 1, wherein
each of a plurality of the image pickup devices is provided in a vicinity of a causal object of the blind spot from a driver;
the sensing device is a line of sight sensor provided on the interior of the vehicle to sense eye location or a direction of a line of sight of the driver; and
the image control device takes an image using at least an image pickup device located in a direction that is visible from sensed eye location among a plurality of the image display devices, senses an area to become the blind spot based on the eye location or the direction of the line of sight of the driver sensed, and corrects image data in a manner that an image of sensed area to become the blind spot from the driver is displayed on a screen of an image display device located at a position in the direction of the line of sight sensed among a plurality of the image display devices.

4. The image display system for vehicle use according to claim 3, wherein
the line of sight sensor includes an image pickup device provided on the interior of the vehicle to take an image of a face of the driver with visible light, and an image processing device which performs a face recognition processing to image data taken by the image pickup device and senses the eye location or the direction of the line of sight of the driver.

5. The image display system for vehicle use according to claim 3, wherein
the line of sight sensor includes an infrared ray image pickup device provided on the interior of the vehicle to receive infrared rays emitted from a face of the driver, and an image processing device which performs a thermographic processing to image data taken by the infrared ray image pickup device and senses the eye location or the direction of the line of sight of the driver.

6. The image display system for vehicle use according to claim 3, wherein
each of a plurality of the image pickup devices takes an image in an area wider than an area of the causal object of the blind spot from the driver; and
the image control device shifts the image in a manner that a direction visible from the eye location sensed by the line of sight sensor and a predetermined direction specified by the cause object are to be positioned in a vicinity of a center of a screen of an image display device located in the direction visible from the eye location among a plurality of the image display devices.

7. The image display system for vehicle use according to claim 3, wherein
an alarm device is further comprised, and the image control device determines whether the driver is dozing or not based on the direction of the line of sight of the driver sensed by the line of sight sensor, and outputs an alarm from the alarm device when it determines the driver is dozing.

8. The image display system for vehicle use according to claim 1, wherein
the sensing device includes a first speed sensor for sensing a speed of the vehicle and a second speed sensor for sensing a speed of another vehicle traveling ahead, behind or lateral of the vehicle:
a plurality of the image pickup devices includes an image pickup device that takes an image of behind or lateral of the vehicle; and
the image control device displays an image taken by an image pickup device for taking the image of behind or lateral of the vehicle on an image display device located ahead the driver among a plurality of the image display devices, when a speed of another vehicle traveling ahead the vehicle is slower than the speed of the vehicle or when a speed of another vehicle traveling behind or lateral of the vehicle is higher than the speed of the vehicle.

9. The image display system for vehicle use according to claim 8, wherein
the first speed sensor senses the speed of the vehicle from a speedometer of the vehicle, and
the second speed sensor senses a relative speed between another vehicle traveling ahead, behind or lateral of the vehicle and the vehicle.

10. The image display system for vehicle use according to claim 9, wherein
the second speed sensor performs an object recognition processing from image data taken by an image pickup device that takes an image ahead, behind or lateral of the vehicle and calculates the relative speed between another vehicle and the vehicle.

11. The image display system for vehicle use according to claim 1, wherein
the sensing device is a speed sensor sensing device that senses the speed of the vehicle, and the image control device stops image taking operation of one or more image pickup devices previously set among a plurality of image pickup devices corresponding to the speed of the vehicle.

12. The image display system for vehicle use according to claim 1, wherein
the sensing device includes a speed sensor for sensing the speed of the vehicle or a GPS (Global Positioning System) for sensing the position of the vehicle, and the image control device stops image taking operations of a plurality of the image pickup devices when the vehicle has not moved for a predetermined time or more.

13. The image display system for vehicle use according to claim 1, wherein
the sensing device is an inter-vehicular distance sensor for sensing an inter-vehicular distance with another vehicle traveling ahead, behind, or lateral of the vehicle, and displays an image taken by an image pickup device which takes an image behind or lateral of the vehicle on an image display device located ahead the driver when the inter-vehicular distance to another vehicle is shorter than a predetermined inter-vehicular distance.

14. The image display system for vehicle use according to claim 13, wherein
the sensing device includes a speed sensor for sensing the speed of the vehicle, and a value of the predetermined inter-vehicle distance is varied corresponding to the speed of the vehicle.

15. The image display system for vehicle use according to claim 13, wherein
the sensing device further includes a GPS (Global Positioning System), and a value of the predetermined inter-vehicle distance is varied corresponding to whether a load on which the vehicle is traveling is a general road or an expressway.

16. The image display system for vehicle use according to claim 1, wherein
at least one of a plurality of the image display devices is an image display device using a flexible organic light emitting diode.

17. The image display system for vehicle use according to claim 3, wherein
each of a plurality of the image pickup devices includes an infrared ray image pickup element for sensing a person existing within a predetermined area to he taken by the image pickup device.

18. The image display system for vehicle use according to claim 3, wherein
the image control device determines whether a person exists in an image taken by a plurality of the image pickup devices or not.

19. A vehicle provided with the image display system according to claim 1, wherein
at least a part of a plurality of the image pickup devices is provided in a vicinity of A-pillar of an exterior portion of the vehicle; and
at least a part of a plurality of the image display devices is an image display device using a flexible organic light emitting diode and is provided with A-pillar portion between a window and another window of the vehicle to be substantially continuous to the windows.

20. The vehicle according to claim 19, wherein
at least another part of a plurality of the image display devices is an image display device using a flexible organic light emitting diode and provided in a portion other than the pillar of the vehicle.

21. The vehicle according to claim 19, wherein
at least a part of a plurality of the image display devices is an image display device using an organic light emitting diode having translucency in a state of not emitting light.

22. The vehicle according to claim 21, wherein
a plurality of the image pickup devices include front image pickup elements and rear image pickup elements, and images taken by taken by the rear image pickup elements are displayed on left and right portions of the image display device provided at lower portion of the windshield.
